(19) United States
(12) Patent Application Publication
(10) Pub. No.: US 2023/0350602 A1
(43) Pub. Date: Nov. 2, 2023

(54) VEHICLE CONTROL SYSTEM AND PROGRAM WRITING METHOD

(71) Applicant: HONDA MOTOR CO., LTD., Tokyo (JP)

(72) Inventor: Yosuke Shionoya, Tokyo (JP)

(21) Appl. No.: 18/178,659

(22) Filed: Mar. 6, 2023

(30) Foreign Application Priority Data
Mar. 31, 2022 (JP) 2022-061004

(51) Int. Cl. G06F 3/06

(52) U.S. Cl. CPC G06F 3/0655; G06F 3/0604; G06F 3/0673

(57) ABSTRACT

A vehicle control system includes plural vehicle control units and a master control unit which is connected with the plural vehicle control units to be capable of communication, the vehicle control unit includes a non-volatile program storage unit that has: a rewritable program storage area which stores a program for controlling a function unit installed in a vehicle; and an information storage area which stores attribute information corresponding to an attribute of the vehicle control unit, the master control unit includes a non-volatile master storage unit which stores writing data for writing the program to the program storage unit, and the writing data include vehicle control unit information for performing communication by designating the vehicle control unit and the attribute information of the vehicle control unit.

### INCORPORATION BY REFERENCE

The present application claims priority under 35 U.S.C.§119 to Japanese Patent Application No. 2022-061004 filed on Mar. 31, 2022. The content of the application is incorporated herein by reference in its entirety.

### BACKGROUND OF THE INVENTION

### Field of the Invention

The present invention relates to a vehicle control system and a program writing method.

### Description of the Related Art

In recent years, with sophistication of functions of vehicles, an increase in electronic control units (ECU) installed in a vehicle and sophistication of programs controlling ECUs have been progressing. For example, achievement in research and development about an improvement in fuel efficiently which contributes to higher energy efficiency has been applied to vehicles, and enhancement of functions of an ECU which controls an engine or a motor has been progressing. Further, installation of a sophisticated ECU which deals with driving assistance technologies and preventive safety technologies has been progressing. With such technological evolution, management of programs installed in an ECU has become an important problem. For example, Japanese Patent Laid-Open No. 2019-144669 discloses a method of updating an ECU which is installed in a vehicle.

### SUMMARY OF THE INVENTION

With enhancement in functionality of ECUs and programs, subdivision of programs based on specifications or destinations of vehicles has been progressing. Thus, in manufacturing steps of a vehicle, it is necessary to check and manage a specification or a version of a program provided to an ECU. However, there has been a problem that when a large number of ECUs are installed in a vehicle, time and labor are required for such management of the programs.

An object of the present invention, which has been made in consideration of such a background, is to enhance efficiency of management of a program for an ECU to be installed in a vehicle.

One aspect for achieving the above object provides a vehicle control system including: plural vehicle control units; and a master control unit which is connected with the plural vehicle control units to be capable of communication, in which the vehicle control unit includes a non-volatile program storage unit that has: a rewritable program storage area which stores a program for controlling a function unit installed in a vehicle; and an information storage area which stores attribute information corresponding to an attribute of the vehicle control unit, the master control unit includes a non-volatile master storage unit which stores writing data for writing the program to the program storage unit, and the writing data include vehicle control unit information for performing communication by designating the vehicle control unit and the attribute information of the vehicle control unit.

In the above configuration, it is possible to determine whether or not a program which is stored in a vehicle control unit installed in a vehicle is compatible with information provided to a master control unit. Accordingly, it is possible to detect inconsistency in the program written to the vehicle control unit by the master control unit installed in the vehicle. Consequently, in manufacturing steps of the vehicle, it is possible to efficiently manage the program stored in the vehicle control unit. Thus, while installation, in the vehicle, of vehicle fuel-efficiency improvement technologies which contribute to higher energy efficiency, driving assistance technologies, preventive safety technologies, and so forth is handled, higher efficiency of management of a program used in the vehicle can be intended.

### BRIEF DESCRIPTION OF THE DRAWINGS

FIG. 1 is an outline configuration diagram of a vehicle control system;

FIG. 2 is an explanatory diagram of manufacturing steps of a vehicle;

FIG. 3 is a block diagram illustrating a configuration of a central ECU;

FIG. 4 is a block diagram illustrating a configuration of a target ECU;

FIG. 5 is a flowchart illustrating actions of the vehicle control system;

FIG. 6 is a flowchart illustrating actions of the vehicle control system;

FIG. 7 is a flowchart illustrating actions of the vehicle control system;

FIG. 8 is a flowchart illustrating actions of the vehicle control system; and

FIG. 9 is a flowchart illustrating actions of the vehicle control system.

### DETAILED DESCRIPTION OF THE PREFERRED EMBODIMENT

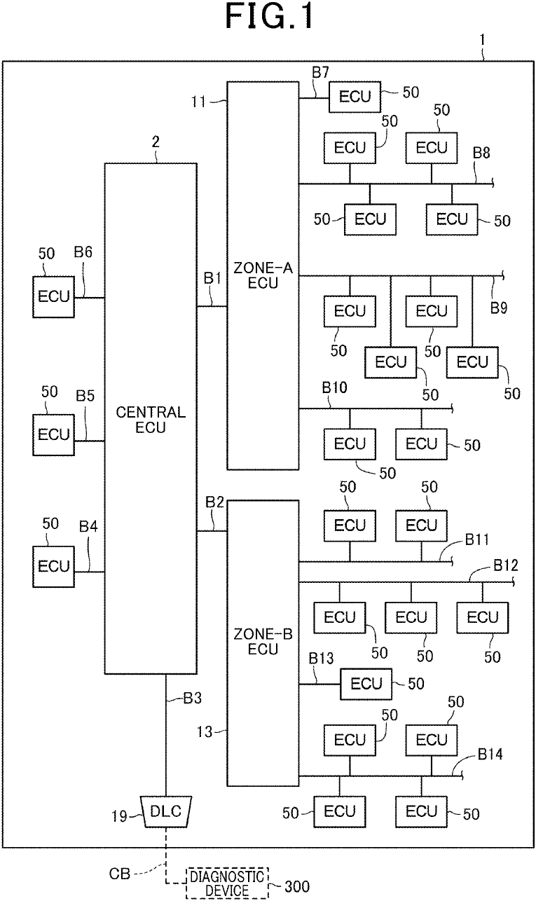

FIG. 1 is a diagram illustrating a vehicle control system 1.

The vehicle control system 1 is formed from plural ECUs 50 which control function units installed in a vehicle. The vehicle control system 1 controls the function units of the vehicle and thereby realizes travel of the vehicle and various functions.

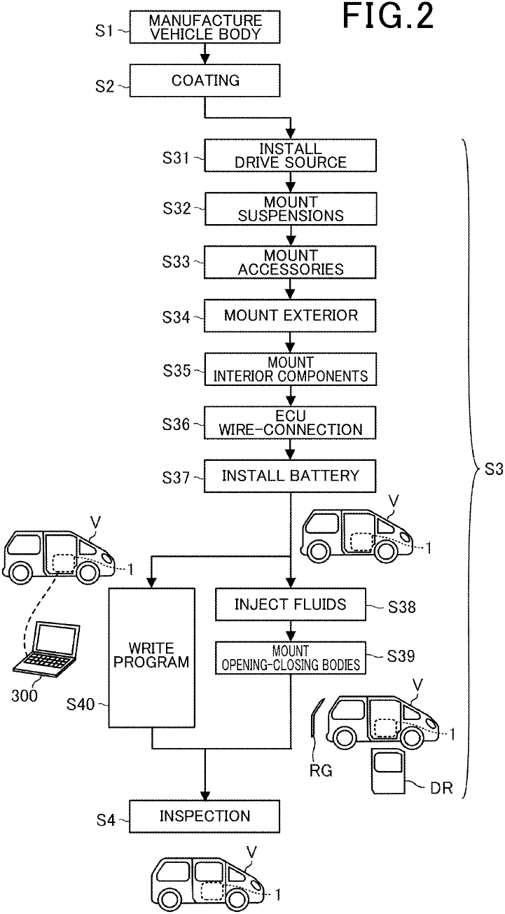

A specific form of the vehicle in which the vehicle control system 1 is installed is not limited. The vehicle may be a four-wheeled automobile or may be a motorcycle or another moving body. The vehicle may be a vehicle which uses an internal combustion engine as a drive source, may be an electric vehicle which uses a motor as a drive source, or may be a hybrid vehicle which uses an internal combustion engine and a motor. In the present embodiment, as illustrated in FIG. 2, a description will be made about a vehicle V, which is a four-wheeled automobile, as an example.

The following description explains examples of various ECUs 50 which are installed in the vehicle V and apparatuses which are controlled by the ECUs 50. It is not intended that the ECUs 50 included in the vehicle V as an application target of the present disclosure are limited to a manner of connection illustrated in FIG. 1.

The vehicle control system 1 includes a central ECU 2 which performs general control of the vehicle V and information processing. The central ECU 2 is connected with communication lines including communication wires B1 to B6. The central ECU 2 realizes a function of a gateway which manages delivery and acceptance of communication data among those communication lines. The central ECU 2 executes writing of programs to be executed by the ECUs for the ECUs which are connected with the central ECU 2 by the communication wires B1 to B6 and for the ECUs which are connected with the above ECUs by other communication wires B7 to B14. Writing of a program includes update of a program which is already written in the ECU and newly writing a program in the ECU. The central ECU 2 executes over-the-air (OTA) management, for example. The OTA management includes control about a process of downloading an update program for the ECU included in the vehicle V from a server on the outside of the vehicle and about a process of applying a downloaded update program to an in-vehicle device, for example. The central ECU 2 corresponds to one example of a master control unit in the present disclosure, and each of the ECUs to which a program is written by the central ECU 2 corresponds to one example of a vehicle control unit. The vehicle control unit includes a zone-A ECU 11, a zone-B ECU 13, and the ECUs 50 illustrated in FIG. 1, for example.

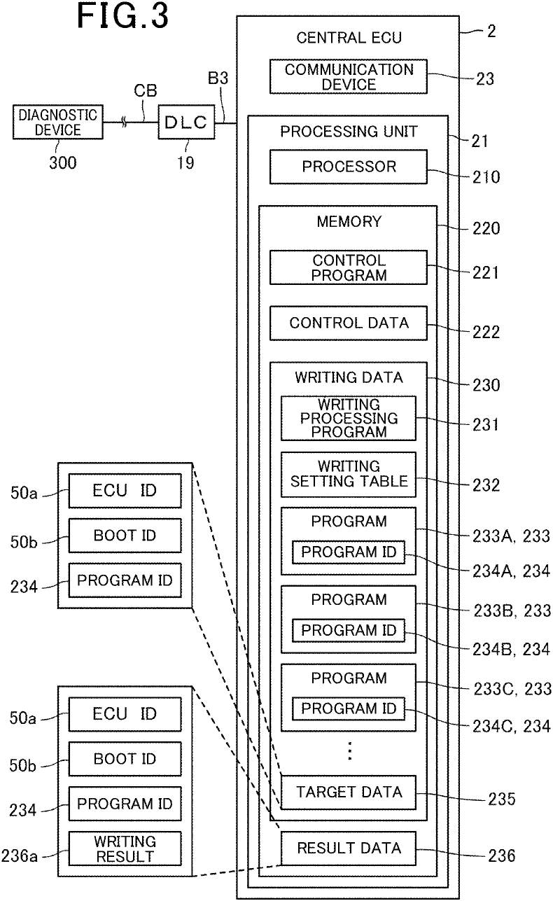

In FIG. 1 and FIG. 3 described later, each of various ECUs which are connected with the central ECU 2, the zone-A ECU 11, and the zone-B ECU 13 is denoted as ECU 50. Each ECUs has a processor and a memory.

With the central ECU 2, the zone-A ECU 11 is connected by the communication wire B1, and the zone-B ECU 13 is connected by the communication wire B2. As described later, in addition, plural ECUs 50 are connected with the zone-A ECU 11 and the zone-B ECU 13. The zone-A ECU 11 manages delivery and acceptance of communication data between the central ECU 2 and the ECUs 50 which are connected with the zone-A ECU 11. The zone-B ECU 13 manages delivery and acceptance of communication data between the central ECU 2 and the ECUs 50 which are connected with the zone-B ECU 13.

With the central ECU 2, a data link connector (DLC) 19 is connected by the communication wire B3. The DLC 19 is an interface device which connects external devices of the vehicle V with the central ECU 2. The DLC 19 includes a connector with which a communication cable is connectable and is connected with a diagnostic device 300, for example, via the communication cable CB. The DLC 19 corresponds to one example of a connection unit in the present disclosure.

The diagnostic device 300 is a terminal device which is configured by a computer and used by a worker in manufacturing steps of the vehicle V. The diagnostic device 300 is connected with the DLC 19 by the communication cable CB, for example. The diagnostic device 300 performs transmission and reception of various commands and data to and from the vehicle control system 1, thereby acquires information about the vehicle control system 1, and transmits an instruction to the vehicle control system 1. The diagnostic device 300 includes operation units such as keys and switches which are operated by the worker, a display unit which displays an action state of the diagnostic device 300 and information about the vehicle control system 1, a connector for connecting with the communication cable CB, and so forth. The diagnostic device 300 corresponds to one example of an external device in the present disclosure.

With the central ECU 2, plural ECUs 50 are connected by the communication wires B4, B5, and B6. Those ECUs 50 include a vehicle-to-everything (V2X) communication device, for example. The V2X communication device is a communication device that includes a communication antenna and a communication circuit, which are not illustrated, and that has a wireless communication function and performs vehicle-to-vehicle communication or road-to-vehicle communication in accordance with control by the central ECU 2. The ECUs 50 which are connected with the central ECU 2 may include a telematics control unit (TCU). The TCU is a wireless communication device that includes a communication antenna and a communication circuit, which are not illustrated, and that executes wireless data communication by a cellular communication system such as long-term evolution (LTE) or the fifth-generation mobile communication system (5G). The ECUs 50 which are connected with the central ECU 2 may include an in-vehicle infotainment (IVI) ECU. With the IVI-ECU, in-vehicle apparatuses such as an automotive navigation system, various cameras including a rear camera, an audio player, a monitor, a touch panel, operation elements such as keys and switches, a speaker, and a microphone are connected. The IVI-ECU controls the in-vehicle apparatuses and thereby provides various kinds of information and entertainment for an occupant of the vehicle V. For example, the IVI-ECU executes control such as starts and stops of the in-vehicle apparatuses, control for outputting data and so forth, which are detected by a sensor by the other ECU, and so forth.

The ECUs 50 which are connected with the central ECU 2 may include a driving assistance ECU which executes control for automatically parking the vehicle V at a parking position or an assistance function in a case where a driver parks the vehicle V. Function units as control targets of the driving assistance ECU include various cameras, a monitor, a touch panel, a steering device, a brake mechanism, and an acceleration device, which are installed in the vehicle V, for example.

The DLC 19 is one example of a function unit which is controlled by the central ECU 2. The same applies to the V2X communication device and the TCU.

With the zone-A ECU 11, plural ECUs 50 are connected by the communication wires B7 to B10. The ECUs 50 which are connected with the zone-A ECU 11 include a fuel injection (FI) control unit, a motor control unit, a battery (BATT) control unit, a shift control unit, a vehicle stability assist (VSA) control unit, and so forth, for example. The ECUs 50 which are connected with the zone-A ECU 11 by the communication wires B7 to B10 can be considered to be function units as control targets of the zone-A ECU 11.

The FI control unit controls a fuel injection amount and a fuel injection timing in an internal combustion engine which is installed in the vehicle V. Function units as control targets of the FI control unit include an electronic control fuel injection device and may include sensors. As sensors, an O2 sensor, a knock sensor, a cam angle sensor, a crank angle sensor, an intake air temperature sensor, an exhaust gas temperature sensor, and so forth can be raised. The motor control unit controls a rotation speed of a motor which is installed in the vehicle V. Function units as control targets of the motor control unit include an inverter circuit which supplies a driving current to the motor and may include various sensors. The BATT control unit performs charge control, discharge control, and management of a remaining charge amount for a traveling battery which is installed in the vehicle V. A battery as a function unit as a control target of the BATT control unit is a battery that is separately provided from a starting battery which supplies power to each unit of the vehicle control system 1 and is installed in the vehicle V for supplying a driving power source for the motor. The traveling battery may be a lithium-ion secondary battery, a lithium polymer battery, a nickel-metal hydride battery, a solid-state battery, another secondary battery, or a capacitor. Function units as control targets of the BATT control unit may include a regenerative mechanism which generates regenerative power by traveling energy of the vehicle V. Meanwhile, the starting battery of the vehicle V is a secondary battery which supplies power to each unit of the vehicle control system 1 in a state where a power source of the vehicle V is turned off and is charged by a generating device installed in the vehicle V during travel of the vehicle V. For example, the starting battery is formed from a lead-acid battery, another secondary battery, or a capacitor.

The shift control unit controls a shift mechanism of the vehicle V in accordance with a traveling state of the vehicle V and an operation by the driver. Function units as control targets of the shift control unit include the shift mechanism of the vehicle V, and specifically, a step automatic transmission (AT), a continuously variable transmission (CVT), a dual clutch transmission (DCT), or the like is raised. The function units as the control targets of the shift control unit may include a shift position sensor, a shift switch, a shift lever, and so forth.

A function unit as a control target of the VSA control unit is an actuator provided to a brake mechanism of the vehicle V, for example. The VSA control unit causes the actuator of the brake mechanism to act in accordance with a posture or the like of the vehicle V and thereby stabilizes the posture of the traveling vehicle V, and in advance prevents a slip and a spin, for example.

With the zone-B ECU 13, plural ECUs 50 are connected by the communication wires B11 to B14. The ECUs 50 which are connected with the zone-B ECU 13 includes a light control unit and an entry control unit, for example. The ECUs 50 which are connected with the zone-B ECU 13 by the communication wires B11 to B14 can be considered to be function units as control targets of the zone-B ECU 13.

Function units as control targets of the light control unit are lamp bodies which are installed in the vehicle V, that is, lighting devices. For example, the control targets of the light control unit include headlights, direction indicators, fog lamps, brake lights, and reversing lights. The light control unit may control a lamp body, which illuminates an inside of a vehicle cabin of the vehicle V, as a control target. A function unit as a control target of the entry control unit is a wireless communication device which performs wireless communication with a key with a fob or another electronic key of the vehicle V. The entry control unit executes communication with the key of the vehicle V, thereby processes user access to the vehicle control system 1 from the outside of the vehicle, and realizes an action of so-called smart entry.

The communication wires B1 to B14 are formed from plural communication transmission paths which conform to various communication standards. Each of the communication wires B1 to B14 can be provided as a data transmission path which conforms to a different communication standard. That is, a specific configuration, a transmission band, and a communication standard of a cable that constitutes each of the communication wires B1 to B14 are arbitrarily selected. As communication standards which are applicable to the communication wires B1 to B14, for example, a controller area network (CAN), Ethernet®, a universal serial bus (USB), a local interconnect network (LIN), and a low-voltage differential signaling (LVDS) can be raised, but other standards may be used. The communication wires B1 to B6 are illustrated, in FIG. 1, as independent communication lines, but their specific configurations are not restricted, and for example, the communication wires B1 to B6 may be bus communication lines, which are connected with plural apparatuses, similarly to the communication wires B7 to B14.

FIG. 2 is an explanatory diagram of the manufacturing steps of the vehicle V. FIG. 2 is a diagram which illustrates an outline of the manufacturing steps of a four-wheeled automobile while dividing the outline based on principal contents but does not limit details of the manufacturing steps of devices of the vehicle. For example, a step indicated as one step in FIG. 2 may include plural detailed steps. The order of steps which is illustrated in FIG. 2 may appropriately be switched. As for manufacturing of the vehicle V, performance of a step which is not illustrated in FIG. 2 is not excluded.

The steps illustrated in FIG. 2 indicate steps of a main manufacturing line in a manufacturing factory of the vehicle V in a simplified manner, for example. In the manufacturing steps of the vehicle V, other steps in a so-called sub-line, which is different from the main manufacturing line, may be conducted, and although other steps may be conducted in another manufacturing factory or component factory, those steps are skipped in FIG. 2.

Step S1 denotes a vehicle body manufacturing step. In the vehicle body manufacturing step, various treatments such as pressing and welding are performed for row materials such as steel and aluminum materials or for structure components which are manufactured in another factory. In step S1, a vehicle body of the vehicle V, a so-called frame is manufactured.

Step S2 denotes a coating step. In the coating step, coating for the vehicle body manufactured in step S1 is performed.

Step S3 denotes an assembling step. In the assembling step, exterior components, interior components, driving system components, and other various components are mounted on the vehicle body for which coating is performed in the coating step. Following step S3, in step S4, an inspection step is performed. In the inspection step in step S4, a completion inspection of the vehicle V is performed.

In FIG. 2, the assembling step in step S3 is more specifically illustrated.

The assembling step includes a drive source installation step (step S31), a suspension mounting step (step S32), an accessory mounting step (step S33), an exterior mounting step (step S34), an interior component mounting step (step S35), an ECU wire-connection step (step S36), and a battery installation step (step S37).

In the drive source installation step (step S31), an internal combustion engine and/or a motor as drive sources of the vehicle V are mounted on the vehicle body. In manufacturing the vehicle V having the internal combustion engine, in step S31, components of an intake system and an exhaust system which are connected with the internal combustion engine are mounted. In manufacturing the vehicle V in which the motor is installed, in step S31, the traveling battery is mounted. In step S31, a transmission may be mounted together with the drive source. In step S31, a part or all of the ECUs 50 to be connected with the drive source are installed in the vehicle body. For example, in step S31, the ECUs 50 such as the FI control unit, the motor control unit, the BATT control unit, and the shift control unit may be installed in the vehicle body.

In the suspension mounting step (step S32), a suspension mechanism which is assembled in a sub-line is mounted on the vehicle body.

In the accessory mounting step (step S33), accessories of the vehicle V are mounted. The accessories include a compressor, a condenser, refrigerant piping, an alternator, a cooling water pump, a cooling water tank, cooling water piping, and an electric oil pump, which constitute an air-conditioning device, for example, and may include other components. In the accessory mounting step, installation, connection, and so forth of brake fluid piping may be performed.

In the suspension mounting step and the accessory mounting step, a part or all of the ECUs 50 to be connected with suspensions and accessories are installed in the vehicle body. In the suspension mounting step and the accessory mounting step, the ECU 50 such as the VSA control unit may be installed in the vehicle body.

In the exterior mounting step (step S34), exterior components such as bumpers, glass other than door glass, wipers, and lamp bodies are mounted. In the interior component mounting step (step S35), interior components of the vehicle V are mounted. The interior components include seats and a center console. In the interior component mounting step, a monitor or a touch panel of an automotive navigation system, a meter panel, and various cameras are mounted on the vehicle body.

In the exterior mounting step and the interior component mounting step, a part or all of the ECUs 50 to be connected with the exterior components and so forth are installed in the vehicle body. For example, in the exterior mounting step or the interior component mounting step, the ECUs 50 such as the light control unit and the entry control unit may be installed in the vehicle body.

In the ECU wire-connection step (step S36), the central ECU 2, the zone-A ECU 11, and the zone-B ECU 13 are installed in the vehicle body. In addition, in the ECU wire-connection step, the ECUs 50, which are not installed in steps S31 to S35, among the ECUs 50 which constitute the vehicle control system 1 are installed in the vehicle body. In the ECU wire-connection step, wire-connection of the communication wires B1 to B6 is made with the central ECU 2. For example, wire-connection of the communication wires B1 to B6 is made with one or plural connectors, and in the ECU wire-connection step, the connectors are connected with the central ECU 2. In addition, in the ECU wire-connection step, the communication wires B7 to B10 are connected with the zone-A ECU 11, and the communication wires B11 to B14 are connected with the zone-B ECU 13. By the ECU wire-connection step, the central ECU 2, the zone-A ECU 11, and the zone-B ECU 13 are mutually connected with the apparatuses as the control targets and the ECUs 50, and a state is established where control by the central ECU 2 is possible. That is, all of the ECUs 50 which have to be directly connected with the central ECU 2 and the ECUs 50 which have to be connected with the central ECU 2 via the zone-A ECU 11 and the zone-B ECU 13 are connected in the ECU wire-connection step. In the ECU wire-connection step, in a state where the vehicle control system 1 is not energized, a connection test may be performed which is for checking electrical connection states between the central ECU 2 and the various ECUs 50 which are connected with the central ECU 2.

By a wire-connection step of the ECU wire-connection step, the central ECU 2, the zone-A ECU 11, and the zone-B ECU 13 are mutually connected with the apparatuses as the control targets and the ECUs 50, and a state is established where control by the central ECU 2 is possible.

The ECU wire-connection step in step S36 corresponds to one example of a wire-connection step in the present disclosure. Because the central ECU 2 and the ECUs 50 are installed in steps S31 to S36, those steps correspond to one example of a providing step in the present disclosure.

After the ECU wire-connection step (step S36), in the battery installation step (step S37), the starting battery is installed in the vehicle V. Wire-connection of the starting battery is made with the vehicle control system 1 in the ECU wire-connection step. As described above, the starting battery supplies power to the vehicle control system 1. Power of the starting battery is supplied as a power source for at least the central ECU 2, the zone-A ECU 11, and the zone-B ECU 13. After step S37, the vehicle control system 1 is started by power supplied by the starting battery and is set to a state where each unit of the vehicle control system 1 is capable of executing control. Specifically, after the step S37, the diagnostic device 300 is connected with the DLC 19, and the diagnostic device 300 is thereby capable of executing communication with the central ECU 2.

After the battery installation step (step S37), a fluid injection step (step S38) and an opening-closing body mounting step (step S39) are performed for the vehicle V. In step S38, various liquids used for the vehicle V are injected. For example, in step S38, cooling water is injected into a water-cooling mechanism which cools the drive source of the vehicle V. A brake fluid is injected into brake piping of the vehicle V. In the fluid injection step, other liquids may be injected.

In step S38, opening-closing bodies of the vehicle V are mounted. As the opening-closing bodies, for example, doors DR and a rear gate RG are raised. In step S38, the assembling step (step S3) is completed, and the inspection step in step S4 is executed.

Step S37 corresponds to one example of an injection step in the present disclosure, and step S38 corresponds to one example of an opening-closing body mounting step in the present disclosure.

In the manufacturing steps of the vehicle V of the present disclosure, in parallel with steps S38 and S39, a program writing step (step S40) is executed. Step S40 corresponds to one example of a writing step in the present disclosure.

The program writing step is started after the battery installation step (step S37) and before the fluid injection step (step S38) or after the fluid injection step. The program writing step may be finished before the opening-closing body mounting step (step S39) is started or may be continued to be executed after the opening-closing body mounting step (step S39) is started.

In the program writing step, the central ECU 2 writes programs to the ECUs 50 included in the vehicle control system 1. Targets of the program writing step include the ECUs 50 which are connected with the central ECU 2 by the communication wires B4 to B6, the ECUs 50 which are connected with the zone-A ECU 11 by the communication wires B7 to B10, and the ECUs 50 which are connected with the zone-B ECU 13 by the communication wires B11 to B14. In the program writing step, programs may be written to the zone-A ECU 2 and the zone-B ECU 13.

In the program writing preparation step, the ECU 50 as a target to which the central ECU 2 writes a program is caused to be in an action mode corresponding to writing of the program. The central ECU 2 executes the program writing step for the ECU 50, on which transition of action mode normally occurs, in the program writing preparation step.

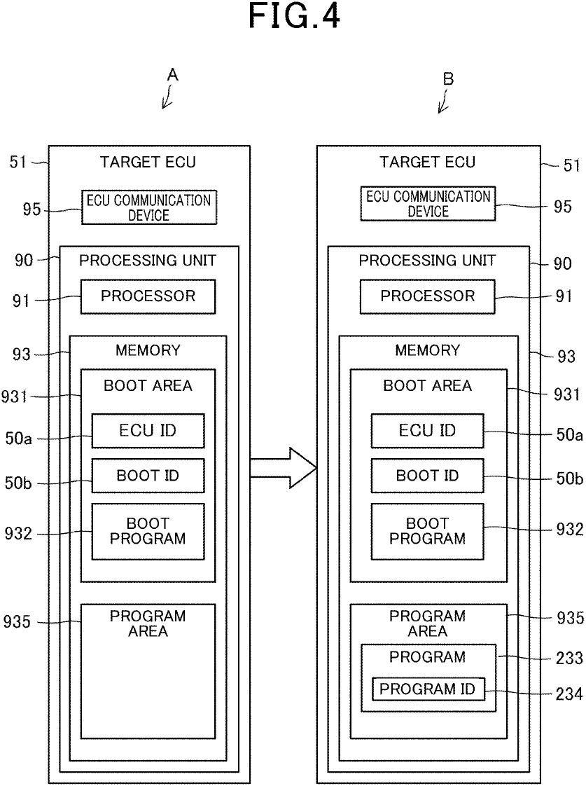

FIG. 3 is a block diagram illustrating a configuration of the central ECU 2. FIG. 4 is a block diagram illustrating a configuration of a target ECU 51. FIG. 4 illustrates a configuration of the target ECU 51, for which writing of a program by the central ECU 2 is still to be performed, by a reference character A and illustrates a configuration of the target ECU 51, for which writing of the program by the central ECU 2 is already performed, by a reference character B.

Here, referring to FIG. 3 and FIG. 4, a description will be made about configurations of the central ECU 2 and the target ECU 51 and about a configuration for realizing writing of the program by the central ECU 2.

In the following description, the ECU as a target to which the program is written by the central ECU 2 will be referred to as target ECU 51. The target ECU 51 may be any ECU other than the central ECU 2 among the ECUs included in the vehicle control system 1. For example, the zone-A ECU 11, the zone-B ECU 13, the IVI-ECU, and so forth can be the target ECUs 51. The FI control unit, the motor control unit, the BATT control unit, and the shift control unit, which are connected with the zone-A ECU 11, can also be the target ECUs 50. The entry control unit, which is connected with the zone-B ECU 13, can also be the target ECU 51. Representative configurations of those ECUs are illustrated in FIG. 4.

As illustrated in FIG. 3, the central ECU 2 has a processing unit 21 and a communication device 23. The communication device 23 has a transmitter and a receiver and executes communication via the communication wires B1 to B6 in accordance with control by the processing unit 21.

The processing unit 21 includes a processor 210 and a memory 220.

The processor 210 is formed from a central processing unit (CPU), a micro-controller unit (MCU), or a micro-processor unit (MPU), for example. The memory 220 is a rewritable non-volatile storage device and stores programs which are executed by the processor 210 and data which are processed by the processor 210. The memory 220 is formed from a semiconductor storage device such as a flash read-only memory (ROM) or a solid state disk (SSD) or a magnetic storage device, for example. The memory 220 may include a random access memory (RAM) which forms a work area for temporarily storing programs and data. The processing unit 21 may be formed from an integrated circuit (IC) which integrally includes the processor 210 and the memory 220. The central ECU 2 may be an integrated circuit in which the processing unit 21 and the communication device 23 are united. The central ECU 2 may be configured to include the communication device 23, the processor 210, and the memory 220 as pieces of independent hardware.

The memory 220 stores a control program 221, control data 222, writing data 230, and result data 235.

The control program 221 is a program which is executed by the processor 210. The control data 222 are data which are referred to in a case where the processor 210 executes the control program 221. The processor 210 executes the control program 221 based on the control data 222 and thereby executes management and control of delivery and acceptance of data in the vehicle control system 1 and communication by the DLC 19. The processor 210 executes the control program 221 and thereby controls the TCU, the meter panel, and so forth. The processor 210 executes the control program 221 and thereby controls the OTA management of the ECUs 50 which constitute the vehicle control system 1. The memory 220 corresponds to one example of a master storage unit in the present disclosure.

The writing data 230 which are stored in the memory 220 by the central ECU 2 are data for writing the program to the target ECU 51 by the processor 210. The writing data 230 include a writing processing program 231, a writing setting table 232, a program 233 for the target ECU 51, and target data 235.

The writing processing program 231 is a program which is executed by the processor 210. The processor 210 executes the writing processing program 231 and thereby executes writing of the program to the target ECU 51 in the manufacturing steps of the vehicle V.

The writing setting table 232 associates the program 233 included in the writing data 230 with the target ECU 51. Each program 233 stored in the memory 220 may be the same as the program which is written to the target ECU 51 by the processor 210 or may be data in which the program 233 is compressed or encoded. A program ID 234 is given to each program 233. The program ID 234, the target data 235, and the result data 236 will be described later.

Meanwhile, as illustrated in FIG. 4, the target ECU 51 includes a processing unit 90 and an ECU communication device 95. The ECU communication device 95 has a transmitter and a receiver and executes communication with the central ECU 2 in accordance with control by the processing unit 90.

The processing unit 90 includes a processor 91 and a memory 93. The processor 91 is formed from a CPU, an MCU, or an MPU, for example. The memory 93 is a rewritable non-volatile storage device and stores programs which are executed by the processor 91 and data which are processed by the processor 91. The memory 93 is formed from a semiconductor storage device such as a flash ROM or an SSD or a magnetic storage device, for example. The memory 93 may include a RAM which forms a work area for temporarily storing programs and data. The processing unit 90 may be formed from an integrated circuit which integrally includes the processor 91 and the memory 93. The target ECU 51 may be an integrated circuit in which the processing unit 90 and the ECU communication device 95 are united. Alternatively, the target ECU 51 may be configured to include the ECU communication device 95, the processor 91, and the memory 93 as pieces of independent hardware.

In a storage area of the memory 93, a boot area 931 and a program area 935 are provided. The boot area 931 and the program area 935 may be provided to the same semiconductor device or may be provided to different semiconductor devices.

The boot area 931 is a non-volatile storage area which stores programs and data. The program area 935 is similarly a non-volatile storage area which stores programs and data. The boot area 931 is an area in which writing and erasure by control by the central ECU 2 are not performed. The memory 93 is a rewritable storage device, but writing and erasure for the boot area 931 by the central ECU 2 are restricted by software or hardware. The boot area 931 corresponds to one example of an information storage area in the present disclosure.

On the other hand, the program area 935 is an area in which writing, erasure, and update by overwriting by control by the central ECU 2 are possible.

The boot area 931 stores an ECU_ID 50a, a boot ID 50b, and a boot program 932. The boot program 932 is a program which is executed by the processor 91 when the target ECU 51 is started and is a basic control program for realizing basic functions of the target ECU 51. The boot program 932 has a function to execute communication with the central ECU 2 by the ECU communication device 95, for example. Thus, the processor 91 executes the boot program 932 and can thereby notify the ECU_ID 50a and the boot ID 50b to the central ECU 2.

The ECU_ID 50a is information which specifies an individual target ECU 51 when the central ECU 2 executes communication with the target ECU 51 and corresponds to one example of vehicle control unit information in the present disclosure. The ECU_ID 50a is defined so as to correspond to a function of the target ECU 51, a type of the target ECU 51, a bus with which the target ECU 51 is connected in the vehicle control system 1, and so forth. The ECU_ID 50a is an address in the communication wires B1 to B14 of the vehicle control system 1, for example. The processor 210 can start communication while specifying the target ECU 51 arranged in the vehicle control system 1 based on the ECU_ID 50a.

The ECU_ID 50a is given to each function of the target ECU 51. For example, a common ECU_ID 50a is given to the target ECUs 51 which execute a common function. Raising the VSA control unit as an example, the VSA control unit which is installed in a first vehicle V and the VSA control unit which is installed in a second vehicle V have the same ECU_ID 50a. The VSA control unit which has a first country as a destination and the VSA control unit which has a second country as a destination have the same ECU_ID 50a. In other words, it can be considered that the ECU_ID 50a is not information which identifies an individual of the target ECU 51 but information which identifies a type in a case where the target ECUs 51 are categorized by functions.

The boot ID 50b is identification information which is given to the target ECU 51 and is information which corresponds to an attribute of the target ECU 51. The boot ID 50b corresponds to one example of attribute information in the present disclosure. The attribute of the target ECU 51 indicates a specification of the vehicle V, a destination of the vehicle V, a model of the vehicle V, a specification of the target ECU 51, and so forth. By the boot ID 50b, the function of the target ECU 51 and the attribute of the target ECU 51 can be specified.

For example, the FI control unit as one example of the ECU 50 is installed in various vehicles V in which internal combustion engines are installed. A manufacturing business operator which manufactures the vehicles V may prepare plural FI control units in order to cause the FI control unit to correspond to a specification of the internal combustion engine with which the FI control unit is combined, constraint by a legal system of a destination, types or specifications of other components which are combined with the internal combustion engine, and so forth. In addition, because of a change in manufacturing steps of the FI control unit or refinements of the FI control unit, the FI control unit of a new version may be supplied. As described above, in a case where plural types of FI control units which have mutual differences are present, the differences among the FI control units are referred to as attribute. The manufacturing business operator of the vehicle V selects the FI control unit which has the attribute compatible with the vehicle V in accordance with the specification of the internal combustion engine which is installed in the vehicle V and the destination and installs the FI control unit in the vehicle V. In this case, the FI control unit which has a different attribute is identifiable by the boot ID 50b which is associated with the attribute of the FI control unit.

As described above, the boot ID 50b is information which is associated with the attribute including the function and the specification of the target ECU 51 and is a component number of the target ECU 51, for example. The boot ID 50b is information common to plural individual target ECUs 51 but is not information which is different among each of the individual target ECUs 51.

As indicated by the reference character A in FIG. 4, the target ECU 51 does not store the program in the program area 935 in a state where the target ECU 51 is installed in the vehicle V. In the present embodiment, the target ECU 51 may store the program in the program area 935 at a time point of installation in the vehicle V or may not store the program. Here, a description will be made by raising, as an example, a configuration in which the target ECU 51 does not store the program in the program area 935.

As indicated by the reference character B in FIG. 4, when writing is performed to the target ECU 51 by the central ECU 2, the program 233 is stored in the program area 935. In a state indicated by the reference character B, it is possible for the target ECU 51 to execute the program 233 by the processor 91. The processor 91 executes the program 233 and thereby controls a function unit as a control target in the vehicle V.

The program 233 which is stored in the program area 935 may be the same as the program 233 included in the writing data 230 or may be the program 233 included in the writing data 230, which has been expanded, for example. The program 233 which is stored in the program area 935 also includes the program ID 234.

Returning to FIG. 3, the writing data 230 include plural programs 233 which correspond to plural target ECUs 51 as writing targets. For example, a program 233A is a program which corresponds to the zone-A ECU 11, a program 233B is a program which corresponds to the zone-B ECU 13, and a program 233C is a program which corresponds to the ECU 50 such as the FI control unit. The number of programs 233 included in the writing data 230 is not restricted. The writing data 230 preferably include the programs 233 which correspond to all of the target ECUs 51 of the vehicle control system 1 of the vehicle V in which the central ECU 2 is installed.

The program ID 234 provided to the program 233 is identification information which is given to the program 233 and corresponds to one example of program information in the present disclosure. The program ID 234 may be embedded in the program 233 or may be information added to the program 233.

The program ID 234 is information which is defined so as to correspond to an attribute of the program ID 234. The writing data 230 include different programs 233 in accordance with differences among functions of the target ECUs 51 in which the programs 233 are installed. In addition, plural types may be present for the programs 233 which correspond to the target ECUs 51 having common functions.

The programs 233 which are installed in the FI control units will be raised as an example. Plural types of programs 233 are present in accordance with the specification of the internal combustion engine with which the FI control unit is combined, constraint by the legal system of the destination, types or specifications of components which are mounted on the internal combustion engine, and so forth. With refinements of the FI control unit or amelioration of the program 233, the program 233 of a new version may be supplied. Consequently, the program 233 which is installed in the FI control unit is the program 233 that is selected from plural programs 233, which mutually have differences, in accordance with the specification or the like of the FI control unit. The difference among those programs 233 will be referred to as attribute. A different program ID 234 is given to the program 233 having a different attribute. The program ID 234 specifies the type of the target ECU 51 in which the program 233 is installed and the attribute of the program 233.

A program ID 234A is information which corresponds to the attribute of the program 233A, and a program ID 234B is information which corresponds to the attribute of the program 233B. A program ID 234C is information which corresponds to the attribute of the program 233C.

The writing setting table 232 includes the ECU_ID 50a and the program ID 234 while associating the ECU_ID 50a with the program ID 234 for the target ECU 51 as a target in which the central ECU 2 installs the program 233. The writing setting table 232 can include information about plural target ECUs 51. For example, the writing setting table 232 associates the program IDs 234 with all of the target ECUs 51 as targets to which the central ECU 2 writes the programs 233. In the present disclosure, the writing setting table 232 corresponds to one example of association data.

The target data 235 are data which associate the ECU_ID 50a, the boot ID 50b, and the program ID 234 with each other. The target data 235 designate the program ID 234 of the program 233 to be installed in the target ECU 51 while associating the program ID 234 with the boot ID 50b. In other words, the target data 235 associate the specification of the target ECU 51 with a specification of the program 233. The target data 235 are generated in accordance with the specification or the destination of the vehicle V. For example, in the diagnostic device 300, the target data 235 are associated with a vehicle identification number (VIN) which specifies an individual of the vehicle V. The program 233 is installed in the target ECU 51 by a combination which is designated by the target data 235, and the target ECU 51 functions in accordance with the specification of the vehicle V.

A combination of the boot ID 50b and the program ID 234 may not be a complete one-to-one combination. For example, plural target ECUs 51 of different specifications may have compatibility of the program 233. In such a case, one common program ID 234 may be associated with plural boot IDs 50b. Conversely, it may be possible to associate plural program IDs 234 with one boot ID 50b.

The result data 236 indicate results of a process in which the central ECU 2 writes the program 233 to the target ECU 51. The result data 236 include the ECU_ID 50a, the boot ID 50b, the program ID 234, and a writing result 236a. The ECU_ID 50a and the boot ID 50b which are included in the result data 236 are information of the target ECU 51 for which a writing process is executed. The program ID 234 is information of the program 233 which is written to the target ECU 51. The writing result 236a is information which indicates whether writing has succeeded or has not succeeded. The result data 236 that include the writing result 236a which indicates that writing has not succeeded correspond to one example of writing error information in the present disclosure.

Before a step in which the central ECU 2 is installed in the vehicle V, the writing data 230 are written to the memory 220. The central ECU 2 performs the process of writing the program 233 to the target ECU 51 in accordance with an instruction from the diagnostic device 300 and in accordance with the writing setting table 232 and the target data 235. In a case where writing of the program 233 to any of the target ECUs 51 has not succeeded, the central ECU 2 can retry writing the program 233 in accordance with an instruction from the diagnostic device 300.

In the following, a description will be made about actions about writing of the program 233 by the central ECU 2.

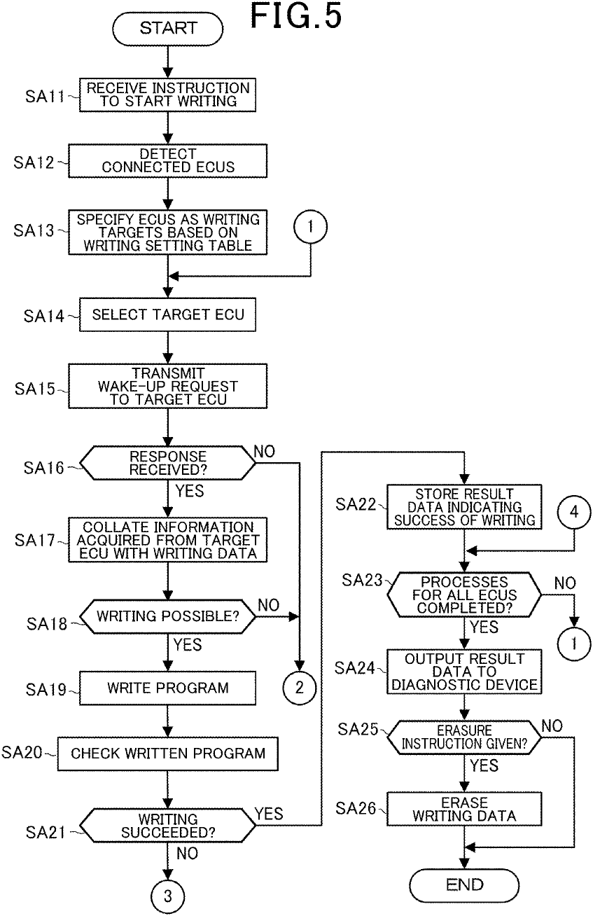

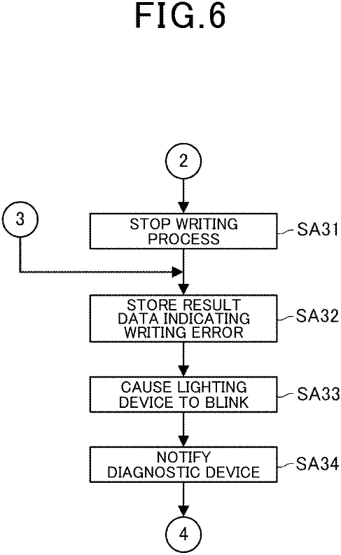

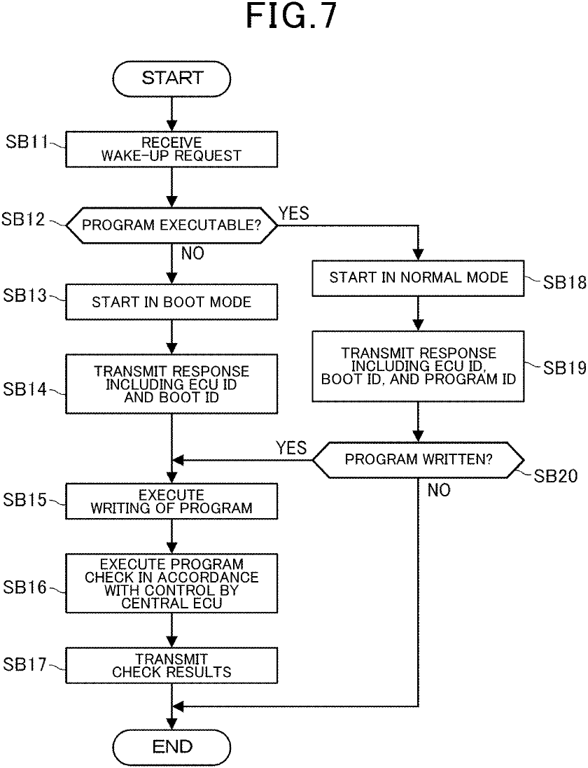

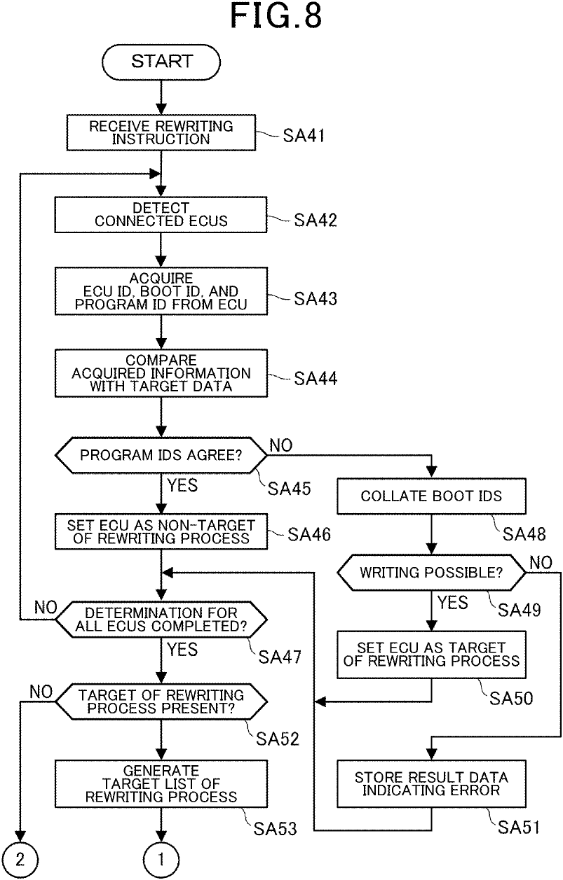

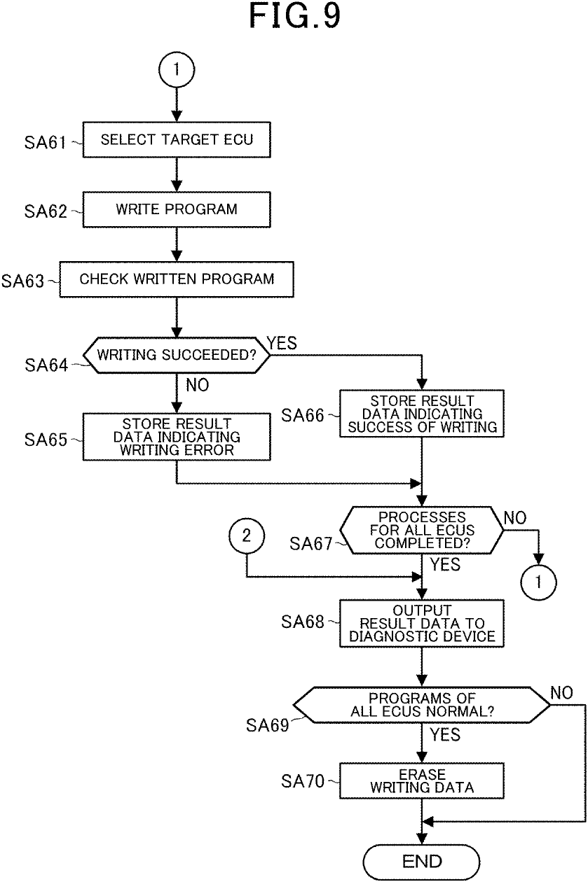

FIG. 5, FIG. 6, FIG. 7, FIG. 8, and FIG. 9 are flowcharts illustrating actions of the vehicle control system 1. FIG. 5 and FIG. 6 illustrate actions in which the central ECU 2 writes the program 233 to the target ECU 51, and FIG. 7 illustrates actions of the target ECU 51. FIG. 8 and FIG. 9 illustrate actions in a case where the central ECU 2 rewrites the program 233 to the target ECU 51.

The actions illustrated in FIG. 5 are executed in a state where the diagnostic device 300 is connected with the DLC 19. Specifically, the worker operates the diagnostic device 300, and the diagnostic device 300 thereby transmits a command for instructing a start of the writing process to the vehicle control system 1. This command serves as a trigger for a start of the writing process.

The processor 210 receives the command from the diagnostic device 300 (step SA11) and detects the target ECUs 51 which are connected with the central ECU 2 (step SA12). In step SA12, the processor 210 detects the target ECUs 51 which are connected with the central ECU 2 by the communication wires B1 to B6 and further the target ECUs 51 which are connected with the central ECU 2 via the zone-A ECU 11 and the zone-B ECU 13. In step SA12, the processor 210 executes access to the target ECU 51 based on the ECU_ID 50a included in the writing setting table 232, for example, and thereby detects the concerned target ECU 51 in the writing setting table 232. In this case, in step SA12, the processor 210 may execute detection based on all of the ECU_IDs 50a included in the writing setting table 232.

The processor 210 specifies the target ECUs 51 set as targets of the writing process based on the writing setting table 232 (step SA13). In step SA13, among the target ECUs 51 detected in step SA12, all of the ECUs are specified which can be the targets of the writing process.

The processor 210 selects one or plural target ECUs 51 from the target ECUs 51 specified in step SA13 (step SA14). In a case where plural target ECUs 51 are selected, the processor 210 may execute actions indicated by steps SA15 to SA26 and SA31 to SA34, which will be described in the following, for one target ECU 51 and may execute those processes in parallel or sequentially for the number of target ECUs 51.

The processor 210 transmits a wake-up request to the target ECU 51 selected in step SA14 (step SA15). The wake-up request is a signal to request the target ECU 51 in the standby state to start. The target ECU 51 is capable of receiving the wake-up request in a state where the power source is supplied by the starting battery. In a normal action, the target ECU 51 transmits a response to the wake-up request to the central ECU 2 as described later by referring to FIG. 9.

The processor 210 determines whether or not the response to the wake-up request is received from the target ECU 51 (step SA16). In a case where the response is not received in a predetermined time period (NO in step SA16), the processor 210 proceeds to step SA31 which will be described later.

In a case where the response is received from the target ECU 51 (YES in step SA16), the processor 210 acquires information included in the response and collates the acquired information with information of the writing data 230 (step SA17). Information acquired from the target ECU 51 is information which is transmitted while being incorporated in the response to the wake-up request by the target ECU 51.

In the present embodiment, in step SA17, the processor 210 compares the ECU_ID 50a acquired from the target ECU 51 with the ECU_ID 50a included in the target data 235. In step SA17, the processor 210 compares the boot ID 50b acquired from the target ECU 51 with the boot ID 50b included in the target data 235.

The processor 210 determines whether or not writing of the program 233 to the target ECU 51 is possible as a result of the collation in step SA17 (step SA18). Specifically, in a case where the combination of the ECU_ID 50a and the boot ID 50b which are acquired from the target ECU 51 agrees with the target data 235, the processor 210 determines that writing of the program 233 is possible (YES in step SA18). On the other hand, in a case where the combination of the ECU_ID 50a and the boot ID 50b which are acquired from the target ECU 51 does not agree with the target data 235, the processor 210 determines that writing is not possible (NO in step SA18).

In a case where it is determined that writing is not possible (NO in step SA18), the processor 210 proceeds to step SA31 which will be described later.

In a case where it is determined that writing is possible (YES in step SA18), the processor 210 writes the program 233, which is designated by the writing setting table 232, to the program area 935 of the target ECU 51 (step SA19).

The processor 210 checks the program 233 which is written to the program area 935 by a process in step SA19 (step SA20). In step SA20, the processor 210 may instruct the target ECU 51 to check the program 233, and the target ECU 51 may thereby execute a check. The processor 210 may read out the program 233 written to the memory 93 and thereby execute the check.

The processor 210 determines whether or not writing of the program 233 is normally completed based on results of the check in step SA20 (step SA21).

In a case where it is determined that writing of the program 233 is not normally completed (NO in step SA21), the processor 210 proceeds to step SA32 which will be described later.

In a case where it is determined that writing of the program 233 is normally completed (YES in step SA21), the processor 210 generates result data 236 that include the writing result 236a which indicates success of writing and stores the result data 236 in the memory 220 (step SA22).

The processor 210 determines whether or not processes for all of the target ECUs 51 specified in step SA13 are completed (step SA23). In other words, the processor 210 determines whether or not all of the target ECUs 51 are selected in step SA14. In a case where it is determined that the processes for all of the target ECUs 51 are completed (YES in step SA23), the processor 210 outputs the result data 236 stored in the memory 220 to the diagnostic device 300 via the DLC 19 (step SA24).

The processor 210 determines whether or not an instruction to erase the writing data 230 is input from the diagnostic device 300 (step SA25). In a case where the instruction for erasure is input (YES in step SA25), the processor 210 erases the writing data 230 from the memory 220 (step SA26) and finishes the current process. In a case where the instruction for erasure is not input (NO in step SA25), the processor 210 skips step SA26 and finishes the current process.

In a case where it is determined that the processes for all of the target ECUs 51 are not completed (NO in step SA23), the processor 210 returns to step SA14 and selects the next target ECU 51.

Meanwhile, in step SA31, the processor 210 stops the process for the target ECU 51 which has been selected (step SA31). Next, in step SA32, the processor 210 generates the result data 236 that include the writing result 236a which indicates a writing error and stores the result data 236 in the memory 220 (step SA32). In step SA32, the processor 210 may generate the writing result 236a that include information which indicates a factor due to which writing has not succeeded. That is, the processor 210 may incorporate, in the writing result 236a, information which indicates whether the factor due to which writing has not succeeded is absence of reception in step SA16, the determination that writing is not possible in step SA18, or the determination that writing is not normally completed in step SA21.

The processor 210 further causes the lamp body installed in the vehicle V to blink (step SA33). In step SA33, for example, the processor 210 controls the light control unit which controls the lamp body and thereby causes the direction indicator of the vehicle V to blink. Accordingly, an occurrence of an error to writing of the program 233 can be notified to the worker who is present along a manufacturing line of the vehicle V. In addition, the processor 210 notifies the occurrence of the error to writing of the program 233 to the diagnostic device 300 via the DLC 19 (step SA34) and proceeds to step SA23. In step SA34, the processor 210 may transmit a signal, which indicates the occurrence of the error to writing of the program 233, to the diagnostic device 300. Alternatively, the processor 210 may transmit the result data 236 to the diagnostic device 300. In this case, an advantage can be obtained where the diagnostic device 300 displays contents of the result data 236 and the worker can thereby be informed of contents of the error in detail.

As illustrated in FIG. 7, the processor 91 of the target ECU 51 receives the wake-up request from the central ECU 2 (step SB11). The target ECU 51 can receive the wake-up request in a state where the power source is supplied by the starting battery. After receiving the wake-up request, the processor 91 may execute initialization of each unit including the memory 93, and so forth.

The processor 91 determines whether or not the program 233 stored in the program area 935 is executable (step SB12). For example, as indicated by the reference character A in FIG. 4, in a case where the program 233 is not stored in the program area 935, the processor 91 determines that the program 233 cannot be executed (NO in step SB12). In a case where writing of the program 233 has failed, the processor 91 also determines that the program 233 cannot be executed (NO in step SB12).

In a case where it is determined that the program 233 cannot be executed (NO in step SB13), the processor 91 is started in a boot mode (step SB13). The boot mode is an action mode in which the processor 91 is started by executing the boot program 932 stored in the boot area 931.

In a case where the processor 91 is started in the boot mode, the processor 91 transmits a response which includes the ECU_ID 50a and the boot ID 50b to the central ECU 2 (step SB14). The response transmitted in step SB14 is received as the response to the wake-up request by the central ECU 2 (step SA16).

Subsequently, the processor 91 executes writing of the program 233 to the program area 935 in accordance with control by the central ECU 2 (step SB15). After writing of the program 233, the processor 91 executes a check of the program 233, which is written to the memory 93, in accordance with control by the central ECU 2 (step SB16), transmits check results to the central ECU 2 (step SB17), and finishes the current process. Note that as described above, in a case where the central ECU 2 executes the check of the program 233 which is written to the memory 93, step SB15 is skipped.

As described above, even in a state where the program 233 is not written to the program area 935, the processor 91 can be started by executing the boot program 932. The processor 91 can transmit the ECU_ID 50a and the boot ID 50b to the central ECU 2. Because the boot program 932, the ECU_ID 50a, and the boot ID 50b arestored in the boot area 931, there is no concern that those disappear due to an influence of access or the like by another device. For example, even when the process of writing the program 233 by the central ECU 2 does not succeed and programs or data which are stored in the program area 935 are set to an inappropriate state, the processor 91 is capable of executing the boot program 932. In this case, because the processor 91 is capable of being started by the boot program 932, the inappropriate state can be resolved.

On the other hand, in a case where the processor 91 is capable of executing the program 233 (YES in step SB12), the processor 91 is started in a normal mode by executing the program 233 (step SB18). The normal mode is an action mode in which the processor 91 controls a function unit as a control target. As the response to the wake-up request, the processor 91 transmits the ECU_ID 50a, the boot ID 50b, and the program ID 234, which is stored in the program area 935, to the central ECU 2 (step SB19).

Subsequently, the processor 91 determines whether or not writing of the program 233 by the central ECU 2 is performed (step SB20). In step SB20, for example, in a case where access for writing the program 233 is performed by the central ECU 2, the processor 91 determines that writing by the central ECU 2 is performed (YES in step SB20).

In a case where it is determined that writing of the program 233 by the central ECU 2 is performed (YES in step SB20), the processor 91 proceeds to step SB15. In a case where it is determined that writing of the program 233 by the central ECU 2 is not performed (NO in step SB20), the processor 91 continues control of the function unit as the control target.

As a result of the actions illustrated in FIG. 5 to FIG. 7, the diagnostic device 300 receives the result data 236 from the central ECU 2. In a case where the result data 236 are present which include the writing result 236a indicating the writing error, the worker who operates the diagnostic device 300 makes a determination about a factor in the writing error. In a case where the writing result 236a includes information which indicates the factor in the writing error, the worker can more easily makes a determination about a measure for resolving the writing error based on the result data 236 that the diagnostic device 300 receives from the central ECU 2.

For example, in a case where a mistake is made in attachment of the ECU which constitutes the vehicle control system 1, replacement or repair for the ECU is performed. As mistakes in attachment of the ECU, for example, attachment of the target ECU 51 of a specification incompatible with the vehicle V, a wire-connection mistake such as unfinished wire-connection or wrong wire-connection with the central ECU 2 or the target ECU 51, and attachment of the central ECU 2 of a specification incompatible with the vehicle V can be raised. In a case where those mistakes are made, the worker performs work for correcting the mistakes in the program writing step (step S40). Specifically, the central ECU 2 or the target ECU 51 which is not adapted to the specification of the vehicle V is replaced, and wire-connection with the central ECU 2 or the target ECU 2 is again performed. Even if a failure of the central ECU 2 or the target ECU 51 occurs, it is possible to perform correction in similar procedures.

After the mistake in attachment of the ECU is corrected by the work of the worker, the worker operates the diagnostic device 300 and thereby transmits a command, which gives an instruction for rewriting, from the diagnostic device 300 to the central ECU 2. Using this instruction as a trigger, a rewriting process illustrated in FIG. 8 and FIG. 9 is started.

A configuration is possible in which before a process in FIG. 8, the diagnostic device 300 transmits the target data 235 to the central ECU 2. In this case, when the writing process illustrated in FIG. 5 to FIG. 7 is executed, the central ECU 2 does not store the target data 235. In a case where the worker corrects the mistake in attachment of the ECU based on the result data 236, the target data 235 are created by the diagnostic device 300 or another device in accordance with contents of the correction. Before transmission of the command which gives the instruction for rewriting from the diagnostic device 300 to the central ECU 2 or together with this command, the worker transmits the target data 235 to the central ECU 2 and causes the central ECU 2 to store the target data.

The processor 210 receives the command, which gives the instruction for rewriting, from the diagnostic device 300 (step SA41) and detects the target ECUs 51 which are connected with the central ECU 2 (step SA42). In step SA42, the processor 210 executes access to the target ECU 51 based on the ECU_ID 50a included in the writing setting table 232 or the target data 235 and thereby detects the target ECU 51. In step SA42, all of the target ECUs 51 do not have to be detected, but for example, one or plural concerned target ECUs 51 in the target data 235 may be detected.

The processor 210 acquires the ECU_ID 50a, the boot ID 50b, and the program ID 234 from the target ECU 51 detected in step SA42 (step SA43).

For example, in the actions of the target ECU 51 which are illustrated in FIG. 7, in a case where the processor 91 is capable of executing the program 233 (YES in step SB12), the processor 91 transmits the ECU_ID 50a, the boot ID 50b, and the program ID 234 to the central ECU 2 (step SB20). The processor 210 acquires this information in step SA43.

For example, in the actions of the target ECU 51 which are illustrated in FIG. 7, in a case where the processor 91 is not capable of executing the program 233 (NO in step SB12), the processor 91 transmits the ECU_ID 50a and the boot ID 50b to the central ECU 2 (step SB14). In this case, the processor 210 acquires the ECU_ID 50a and the boot ID 50b in step SA43.

The processor 210 compares the information acquired from the ECU with the target data 235 (step SA44) and determines whether or not the program ID 234 acquired from the target ECU 51 agrees with the target data 235 (step SA45). To put it in another way, the processor 210 determines whether or not the combination of the boot ID 50b and the program ID 234, which are acquired from the target ECU 51, agrees with the combination of the boot ID 50b and the program ID 234, which are included in the target data 235.

For example, the FI control unit is set as a first target ECU 51, that is, a first vehicle control unit. In this case, the program ID 234 that the FI control unit stores in the program area 935 corresponds to first program information, and the boot ID 50b provided to the FI control unit corresponds to first attribute information. The processor 210 determines whether or not the program ID 234 acquired from the FI control unit agrees with the program ID 234 which is associated with the boot ID 50b of the FI control unit by the target data 235. Here, in a case where the program IDs 234 agree with each other, because a proper program 233 is already written to the FI control unit, the rewriting process does not have to be performed.

In a case where it is determined that the program IDs 234 agree with each other (YES in step SA45), the processor 210 sets the target ECU 51, which transmits the agreeing program ID 234, as a non-target of the rewriting process (step SA46). Subsequently, the processor 210 proceeds to step SA47.

In a case where the program ID 234 acquired from the target ECU 51 does not agree with the target data 235 and a case where the processor 210 does not acquire the program ID 234 from the target ECU 51, the processor 210 determines that the program IDs 234 do not agree with each other (NO in step SA45).

In a case where it is determined that the program IDs 234 do not agree with each other (NO in step SA45), the processor 210 collates the boot ID 50b acquired from the target ECU 51 with the boot ID 50b included in the target data 235 (step SA48). Based on a result of the collation, the processor 210 determines whether or not writing of the program 233 to the target ECU 51 is possible (step SA49).

For example, the FI control unit is set as the first target ECU 51, the program ID 234 that the FI control unit stores in the program area 935 is set as the first program information, and the boot ID 50b provided to the FI control unit is set as the first attribute information. The processor 210 collates the boot ID 50b acquired from the FI control unit with the boot ID 50b included in the target data 235. Here, in a case where the boot ID 50b acquired from the FI control unit is included in the target data 235, this means that the program 233 corresponding to this boot ID 50b is present. In this case, because the central ECU 2 can write the program 233 to the FI control unit in accordance with the program ID 234 which is associated with the boot ID 50b acquired from the FI control unit, the processor 210 determines that writing of the program 233 is possible (YES in step SA49).

Note that correspondence between the program ID 234 and the boot ID 50b may not be one-to-one correspondence as described above, but a combination having compatibility may be present. In a case where the boot ID 50b acquired from the target ECU 51 is included in the target data 235, the processor 210 determines that writing of the program 233 is possible (YES in step SA49).

In a case where the processor 210 determines that writing is possible (YES in step SA49), the processor 210 sets the target ECU 51 as a target of the rewriting process (step SA50) and proceeds to step SA47.

In a case where it is determined that writing is not possible (NO in step SA49), the processor 210 generates the result data 236 that include the writing result 236a which indicates the writing error, stores the result data 236 in the memory 220 (step SA51), and proceeds to step SA47.

In step SA47, the processor 210 determines whether or not the determination in step SA45 is completed for all of the target ECUs 51 which correspond to the ECU_IDs 50a of the target data 235 (step SA47). In a case where the target ECU 51 is present for which the determination in step SA45 is not made (NO in step SA47), the processor 210 returns to step SA42. In a case where the determination is completed for all of the target ECUs 51 (YES in step SA47), the processor 210 determines whether or not the target ECU 51 set as a target of the rewriting process is present (step SA52).

In a case where the target ECU 51 set as the target of the rewriting process is not present (NO in step SA52), the processor 210 proceeds to step SA68 (FIG. 9) which will be described later.

In a case where the target ECU 51 set as the target of the rewriting process is present (YES in step SA52), the processor 210 generates a list of the target ECUs 51 as the targets of the rewriting process and temporarily stores that in the memory 220 (step SA53). Subsequently, the processor 210 proceeds to step SA61 (FIG. 9).

In step SA61, the processor 210 selects one or plural target ECUs 51 from the list of target ECUs 51 (step SA61). The processor 210 writes the program 233, which is designated by the writing setting table 232, to the program area 935 of the selected target ECU 51 (step SA62) .

The processor 210 checks the program 233 which is written to the program area 935 by a process in step SA62 (step SA63). Similarly to step SA20, in step SA63, the processor 210 may instruct the target ECU 51 to check the program 233, or the processor 210 may read out the program 233 from the memory 93 and thereby execute a check.

The processor 210 determines whether or not writing of the program 233 is normally completed based on results of the check in step SA63 (step SA64). In a case where it is determined that writing of the program 233 is not normally completed (NO in step SA64), the processor 210 generates result data 236 that include the writing result 236a which indicates the writing error and stores the result data 236 in the memory 220 (step SA65). Subsequently, the processor 210 proceeds to step SA67.

In a case where it is determined that writing of the program 233 is normally completed (YES in step SA64), the processor 210 generates result data 236 that include the writing result 236a which indicates success of writing and stores the result data 236 in the memory 220 (step SA66). Subsequently, the processor 210 proceeds to step SA67.

In step SA67, the processor 210 determines whether or not processes for all of the target ECUs 51 in the list generated in step SA53 are completed (step SA67). In a case where the target ECU 51 is present for which the process is not performed (NO in step SA67), the processor 210 returns to step SA61.

In a case where the processes for all of the target ECUs 51 are completed (YES in step SA67), the processor 210 proceeds to step SA68 and outputs the result data 236 to the diagnostic device 300 (step SA68). In a case where it is determined that the target ECU 51 as the target of the rewriting process is not present in step SA52, the processor 210 may transmit the result data 236, which indicate that no target of the rewriting process is present, to the diagnostic device 300 in step SA68.

Based on the result data 236, the processor 210 determines whether or not all of the target ECUs 51 designated by the ECU_IDs 50a of the target data 235 have normal programs 233 (step SA69). In a case where all of the target ECUs 51 have the normal programs 233 (YES in step SA69), the processor 210 erases the writing data 230 from the memory 220 (step SA70) and finishes the current process. In step SA70, in addition to the writing data 230, the result data 236 may be erased. In a case where at least a part of the target ECUs 51 do not have the normal programs 233 (NO in step SA69), the processor 210 skips step SA70 and finishes the current process.

The actions illustrated in FIG. 5 to FIG. 9 are executed for at least a part of the target ECUs 51 of the vehicle control system 1 installed in the vehicle V, and work for checking specifications and states of programs of the target ECUs 51 in the manufacturing steps of the vehicle V can thereby be reduced. In addition, when programs are written to a larger number of target ECUs 51 by the actions illustrated in FIG. 5 to FIG. 9, much higher efficiency of the manufacturing steps of the vehicle V can be intended. In a case where the program 233 is not properly written by the actions in FIG. 5 to FIG. 7, the actions in FIG. 8 and FIG. 9 are executed after work for correction, and the rewriting process of the program 233 can thereby be executed. By this rewriting process, a proper program 233 is written to each of the target ECUs 51. Accordingly, writing of the program in the manufacturing steps of the vehicle V can efficiently be performed in a short time period, and even if a mistake in attachment of the target ECU 51 or the central ECU 2 is made, it is possible to properly handle the mistake in a short time period. The rewriting process by the central ECU 2 is realized by a configuration in which the target ECU 51 is capable of being started in the boot mode by executing the boot program 932 and the boot ID 50b is capable of being transmitted to the central ECU 2.

The above embodiment represents one specific example to which the present invention is applied but does not limit forms to which the invention is applied.

In the above embodiment, a description is made about an example where the memory 220 in a state where that in advance stores the writing data 230 is installed in the vehicle V, but this is one example. For example, after the central ECU 2 is installed in the vehicle V, in the ECU wire-connection step (step S36) or the battery installation step (step S37), or before or after those, the writing data 230 may be transmitted from the diagnostic device 300 to the central ECU 2, and the writing data 230 may thereby be stored in the central ECU 2. In this case, because it is sufficient that data or a program to be stored in the memory 220 by the central ECU 2 is prepared before the program writing step (step S40), a further improvement in efficiency in the manufacturing steps of the vehicle V can be intended.

The configuration of the vehicle control system 1 which is described in the above embodiment is one example, and types of the target ECUs 51, the number of target ECUs 51, and configurations of devices as control targets of the target ECUs 51 included in the vehicle control system 1 can variously be changed. The vehicle control system 1 may include the ECU to which the program 233 is not written by the central ECU 2. This kind of ECU does not become the target ECU 51 and may thus be set as a non-target of the actions of FIG. 5 to FIG. 9.

Step units illustrated in FIG. 2 and FIG. 5 to FIG. 9 result from division which corresponds to main process contents for easy understanding of the manufacturing steps of the vehicle V and the actions in the vehicle control system 1 and are not limited by manners of division of the process units or names. Division into more step units may be made in accordance with process contents. Division may be made such that one step unit includes more processes. The order of steps may appropriately be switched.

Contents described in the present embodiment can appropriately be combined. For example, each of a configuration 1 to a configuration 11 which will be described in the following can be combined with the other arbitrary configuration.

The above embodiment supports the following configurations.

(Configuration 1) A vehicle control system including: plural vehicle control units; and a master control unit which is connected with the plural vehicle control units to be capable of communication, in which the vehicle control unit includes a non-volatile program storage unit that has: a rewritable program storage area which stores a program for controlling a function unit installed in a vehicle; and an information storage area which stores attribute information corresponding to an attribute of the vehicle control unit, the master control unit includes a non-volatile master storage unit which stores writing data for writing the program to the program storage unit, and the writing data include vehicle control unit information for performing communication by designating the vehicle control unit and the attribute information of the vehicle control unit.

In the vehicle control system of the configuration 1, it is possible to determine whether or not the program which is stored in the vehicle control unit installed in the vehicle is compatible with information provided to the master control unit. Accordingly, it is possible to detect inconsistency in the program written to the vehicle control unit by the master control unit installed in the vehicle. Consequently, in the manufacturing steps of the vehicle, it is possible to efficiently manage the program stored in the vehicle control unit. Thus, while installation, in the vehicle, of vehicle fuel-efficiency improvement technologies which contribute to higher energy efficiency, driving assistance technologies, preventive safety technologies, and so forth is handled, higher efficiency of management of a program used in the vehicle can be intended.

(Configuration 2) The vehicle control system which is described in the configuration 1, in which based on the writing data, the master control unit executes a writing process of writing the program to the program storage area of the vehicle control unit.

In the vehicle control system of the configuration 2, the master control unit is capable of writing the program to the vehicle control unit. Thus, in the manufacturing steps of the vehicle, the master control unit which is installed in the vehicle can be used to write the program to the vehicle control unit and to detect inconsistency in the program. Accordingly, a step of checking the program of the vehicle control unit and a step of writing the program to each vehicle control unit can be skipped or simplified. Consequently, it is possible to shorten a production time period in the manufacturing factory of the vehicle while an improvement in fuel efficiency of the vehicle and installation of driving assistance technologies and preventive safety technologies in the vehicle are handled, and much higher efficiency of the manufacturing steps of the vehicle and reduction in an emission amount of carbon dioxide can be realized.

(Configuration 3) The vehicle control system which is described in the configuration 2, in which the writing data include the program which is written by the writing process and association data which associate the program with the vehicle control unit, and the master control unit performs the writing process in accordance with the association data.

In the vehicle control system of the configuration 3, in a state where the vehicle control unit and the master control unit are installed in the vehicle, writing of the program to the individual vehicle control unit can be executed. Thus, much higher efficiency of the manufacturing steps of the vehicle and shortening of a time period required for the manufacturing steps of the vehicle can be intended.

(Configuration 4) The vehicle control system which is described in the configuration 2 or the configuration 3, including a connection unit that connects an external device which is present on an outside of the vehicle control system with the master control unit, in which in a case where an instruction is input from the external device, the master control unit starts the writing process for the vehicle control unit.

In the vehicle control system of the configuration 4, the instruction is input to the master control unit by the external device, and the master control unit thereby starts writing of the program to the vehicle control unit. Accordingly, a timing of writing of the program by the master control unit can properly be managed. For example, in a case where the external device is connected with the master control unit in the manufacturing steps of the vehicle, because writing of the program can be started only by inputting the instruction to the mater control unit by the external device, an advantage is present where a workload in the manufacturing steps of the vehicle is small.

(Configuration 5) The vehicle control system which is described in any one of the configuration 2 to the configuration 4, in which the master control unit acquires the attribute information from the vehicle control unit and determines not to execute the writing process in a case where the attribute information acquired from the vehicle control unit is different from the attribute information included in the writing data.

In the vehicle control system of the configuration 5, because writing of the program is not performed in a case where the attribute information provided to the master control unit does not agree with the attribute information of the vehicle control unit, wrong writing can be prevented in a case where the attribute of the vehicle control unit is different from a plan. Accordingly, because a mistake can quickly be detected and handled in the manufacturing steps of the vehicle, much higher efficiency of the manufacturing steps of the vehicle can be intended.

(Configuration 6) The vehicle control system which is described in the configuration 2 or the configuration 3, including a connection unit that connects an external device which is present on an outside of the vehicle control system with the master control unit, in which in a case where a rewriting instruction is input from the external device, the master control unit starts a rewriting process that includes update of the program which is stored in the program storage unit of the vehicle control unit and writing of the program to the program storage unit which does not store the program.

In the vehicle control system of the configuration 6, the instruction is input to the master control unit by the external device, and update of the program of the vehicle control unit and writing of the program to the vehicle control unit can thereby be executed. Accordingly, for example, in a case where writing of the program by the master control unit has not succeeded, writing can again be executed by the master control unit. Accordingly, much higher efficiency of the manufacturing steps of the vehicle can be intended.

(Configuration 7) The vehicle control system which is described in the configuration 6, in which the vehicle control unit stores, in the program storage unit, program information which is given to the program written to the program storage area, the writing data stored in the master storage unit include the program and the program information given to the program, and in the rewriting process, the master control unit acquires first program information from a first vehicle control unit and does not perform update of the program stored in the program storage unit of the first vehicle control unit in a case where the first program information agrees with the program information included in the writing data.

In the vehicle control system of the configuration 7, in a case where the program stored in the vehicle control unit is updated, the program is updated on condition that the program information of the program of the vehicle control unit agrees with the program information provided to the master control unit. Accordingly, improper update of the program can be prevented, and reliability about update of the program can be secured.

(Configuration 8) The vehicle control system which is described in the configuration 7, in which in a case where the first program information does not agree with the program information included in the writing data, the master control unit acquires first attribute information from the first vehicle control unit and determines whether or not the first attribute information agrees with the attribute information included in the writing data.

In the vehicle control system of the configuration 8, in a case where the program information of the vehicle control unit does not agree with the program information provided to the master control unit, the master control unit determines whether or not the attribute of the vehicle control unit is proper. Accordingly, the master control unit can detect a state where the attribute of the vehicle control unit is proper but the program provided to the vehicle control unit is not compatible. Thus, whether or not replacement of the vehicle control unit is necessary and whether or not update of the program without replacing the vehicle control unit is necessary can easily be determined. Consequently, much higher efficiency of the manufacturing steps of the vehicle can be intended.

(Configuration 9) The vehicle control system which is described in the configuration 8, in which in a case where the first attribute information agrees with the attribute information included in the writing data, the master control unit performs update of the program stored in the program storage unit of the first vehicle control unit.

In the vehicle control system of the configuration 9, in a case where the program information of the vehicle control unit does not agree with the program information provided to the master control unit and where the attribute of the vehicle control unit is proper, the program is updated by the master control unit. Accordingly, the master control unit can repair a state where the attribute of the vehicle control unit is proper but the program is not proper. Consequently, much higher efficiency of the manufacturing steps of the vehicle can be intended.

(Configuration 10) The vehicle control system which is described in any one of the configuration 6 to the configuration 9, in which the master control unit specifies one or plural vehicle control units which are set as targets of the rewriting process and erases the writing data stored in the master storage unit after the rewriting process for the specified vehicle control units is completed.

In the vehicle control system of the configuration 10, the writing data stored in the master control unit are erased, and a storage capacity of the master storage unit for which the manufacturing steps of the vehicle are already finished can be secured. Accordingly, when the vehicle is actually used in the market, the storage capacity of the master control unit can effectively be utilized.

(Configuration 11) A program writing method in a vehicle control system including a vehicle control unit which controls a function unit installed in a vehicle by executing a program and a master control unit which is connected with the vehicle control unit, the program writing method including: storing, in a non-volatile master storage unit provided to the master control unit, data for writing the program to the vehicle control unit, the data being writing data which include vehicle control unit information for performing communication by designating the vehicle control unit and attribute information corresponding to an attribute of the vehicle control unit; by the master control unit, acquiring the vehicle control unit information and the attribute information from the vehicle control unit; and deciding whether or not a writing process of writing the program to the vehicle control unit is executed by comparing the vehicle control unit information and the attribute information which are acquired from the vehicle control unit with the vehicle control unit information and the attribute information which are included in the writing data.

In the program writing method of the configuration 11, it is possible to determine whether or not the program which is stored in the vehicle control unit installed in the vehicle is compatible with information provided to the master control unit. Accordingly, it is possible to detect inconsistency in the program written to the vehicle control unit by the master control unit installed in the vehicle. Consequently, in the manufacturing steps of the vehicle, it is possible to efficiently manage the program stored in the vehicle control unit. Thus, while installation, in the vehicle, of vehicle fuel-efficiency improvement technologies which contribute to higher energy efficiency, driving assistance technologies, preventive safety technologies, and so forth is handled, higher efficiency of management of a program used in the vehicle can be intended.

Reference Signs List

| | |
|---|---|
| 1 | vehicle control system |
| 2 | central ECU (master control unit) |
| 11 | zone-A ECU |
| 13 | zone-B ECU |
| 19 | DLC (connection unit) |
| 21 | processing unit |
| 23 | communication device |
| 50 | ECU (vehicle control unit) |
| 50 a | ECU_ID |
| 50 b | boot ID |
| 51 | target ECU (vehicle control unit) |
| 50 a | ECU_ID (vehicle control unit information) |
| 50 b | boot ID (attribute information) |
| 91 | processor |
| 93 | memory (program storage unit) |
| 210 | processor |
| 220 | memory (master storage unit) |
| 221 | control program |
| 222 | control data |
| 230 | writing data |
| 231 | writing processing program |
| 232 | writing setting table (association data) |
| 233, 233A to 233C | program |
| 234, 234A to 234C | program ID (program information) |
| 235 | target data |
| 236 | result data (writing error information) |
| 236 a | writing result |
| 300 | diagnostic device (external device) |
| 931 | boot area (information storage area) |
| 932 | boot program |
| 935 | program area |
| B1 to B14 | communication wire |
| CB | communication cable |
| V | vehicle |

What is claimed is:

1. A vehicle control system comprising:
plural vehicle control units; and a master control unit which is connected with the plural vehicle control units to be capable of communication, wherein
the vehicle control unit includes a non-volatile program storage unit that has: a rewritable program storage area which stores a program for controlling a function unit installed in a vehicle; and an information storage area which stores attribute information corresponding to an attribute of the vehicle control unit,
the master control unit includes a non-volatile master storage unit which stores writing data for writing the program to the program storage unit, and
the writing data include vehicle control unit information for performing communication by designating the vehicle control unit and the attribute information of the vehicle control unit.

2. The vehicle control system according to claim 1, wherein
based on the writing data, the master control unit executes a writing process of writing the program to the program storage area of the vehicle control unit.

3. The vehicle control system according to claim 2, wherein
the writing data include the program which is written by the writing process and association data which associate the program with the vehicle control unit, and
the master control unit performs the writing process in accordance with the association data.

4. The vehicle control system according to claim 2, comprising
a connection unit that connects an external device which is present on an outside of the vehicle control system with the master control unit, wherein
in a case where an instruction is input from the external device, the master control unit starts the writing process for the vehicle control unit.

5. The vehicle control system according to claim 2, wherein
the master control unit acquires the attribute information from the vehicle control unit and determines not to execute the writing process in a case where the attribute information acquired from the vehicle control unit is different from the attribute information included in the writing data.

6. The vehicle control system according to claim 2, comprising
a connection unit that connects an external device which is present on an outside of the vehicle control system with the master control unit, wherein
in a case where a rewriting instruction is input from the external device, the master control unit starts a rewriting process that includes update of the program which is stored in the program storage unit of the vehicle control unit and writing of the program to the program storage unit which does not store the program.

7. The vehicle control system according to claim 6, wherein
the vehicle control unit stores, in the program storage unit, program information which is given to the program written to the program storage area,
the writing data stored in the master storage unit include the program and the program information given to the program, and
in the rewriting process, the master control unit acquires first program information from a first vehicle control unit and does not perform update of the program stored in the program storage unit of the first vehicle control unit in a case where the first program information agrees with the program information included in the writing data.

8. The vehicle control system according to claim 7, wherein
in a case where the first program information does not agree with the program information included in the writing data, the master control unit acquires first attribute information from the first vehicle control unit and determines whether or not the first attribute information agrees with the attribute information included in the writing data.

9. The vehicle control system according to claim 8, wherein
in a case where the first attribute information agrees with the attribute information included in the writing data, the master control unit performs update of the program stored in the program storage unit of the first vehicle control unit.

10. The vehicle control system according to claim 6, wherein
the master control unit specifies one or plural vehicle control units which are set as targets of the rewriting process and erases the writing data stored in the master storage unit after the rewriting process for the specified vehicle control units is completed.

11. A program writing method in a vehicle control system including a vehicle control unit which controls a function unit installed in a vehicle by executing a program and a master control unit which is connected with the vehicle control unit, the program writing method comprising:
storing, in a non-volatile master storage unit provided to the master control unit, data for writing the program to the vehicle control unit, the data being writing data which include vehicle control unit information for performing communication by designating the vehicle control unit and attribute information corresponding to an attribute of the vehicle control unit;
by the master control unit,
acquiring the vehicle control unit information and the attribute information from the vehicle control unit; and
deciding whether or not a writing process of writing the program to the vehicle control unit is executed by comparing the vehicle control unit information and the attribute information which are acquired from the vehicle control unit with the vehicle control unit information and the attribute information which are included in the writing data.
